(19) United States
(12) Patent Application Publication
(10) Pub. No.: US 2017/0139273 A1
(43) Pub. Date: May 18, 2017

(54) ARRAY SUBSTRATE AND LCD DEVICE INCLUDING THE SAME

(71) Applicant: Wuhan China Star Optoelectronics Technology Co., Ltd., Wuhan, Hubei (CN)

(72) Inventor: Chang XIE, Shenzhen, Guangdong (CN)

(73) Assignee: Wuhan China Star Optoelectronics Technology Co., Ltd., Wuhan, Hubei (CN)

(21) Appl. No.: 14/768,020

(22) PCT Filed: Jul. 10, 2015
(86) PCT No.: PCT/CN2015/083742

§ 371 Date: Aug. 14, 2015

(30) Foreign Application Priority Data
Jun. 18, 2015 (CN) 201510340765.4

(51) Int. Cl. G02F 1/1335; G02F 1/1362

(52) U.S. Cl. CPC G02F 1/133528; G02F 1/136209; G02F 1/133514; G02F 1/133512; G02F 2001/133538

(57) ABSTRACT

The present invention provides an array substrate and a liquid crystal display (LCD) device including the array substrate. The LCD device contains upper and lower polarizer films of perpendicular first and second polarization directions, respectively. The array substrate contains a number of pixel units, each containing a number of metallic lines for supplying voltage. Each metallic line is configured in a stairwise manner along a third direction that is other than the first and second directions where at least some segments of the metallic line has an included angle relative to the first or second direction less than a preset value. Through the above arrangement, the present invention is capable of achieving reduce dark-state light leakage.

### BACKGROUND OF THE INVENTION

1. Field of the Invention

The present invention generally relates to liquid crystal display (LCD) technologies, and particularly relates to an array substrate and a LCD device including the array substrate.

2. The Related Arts

As the liquid crystal display (LCD) technology continuously evolves, LCD devices have become the mainstream type of display devices. LCD devices have advantages such as low power consumption, thin body, soft image that is not harmful to the eyes, and therefore are widely popular.

In the design of LCD device, the pixels have some metallic lines to supply voltage to the pixel electrodes or the common electrodes. As shown in FIG. 1, a pixel unit 10 contains a pixel electrode 101 and metallic lines 102 to supply voltage to the pixel electrode 101. As shown in FIG. 2, each metallic lines 102 has a thickness with a trapezoid cross section having two slopes. When liquid crystal molecules 11 are aligned, liquid crystal molecules 11 on the slopes are arranged along the slopes and therefore are tilted.

According to existing technology, the metallic lines 102 are laid out linearly and have an included angle relative to the lateral direction. For example, the circled section shown in FIG. 1 has a 45° included angle relative to the lateral direction. Then, when the liquid crystal molecules 11 are aligned, those on the slopes of the metallic lines 102 would have a 45° included angle relative to the lateral or vertical direction, as shown in FIG. 3. When the upper and lower polarizer films have polarization directions along the lateral and vertical directions, the liquid crystal molecules on the slopes of the metallic lines 102 would have a 45° included angle relative to the polarization directions of the upper or lower polarizer films. As such, when the polarized light from the lower polarizer film passes through the liquid crystal molecules on the metallic lines' slopes, the polarization direction of the polarized light is twisted for some degree. The resulted polarized light is no longer perpendicular to the polarization direction of the upper polarizer film, thereby causing dark-state light leakage and reduced contrast.

### SUMMARY OF THE INVENTION

The present invention teaches an array substrate and a liquid crystal display (LCD) device including the array substrate that can reduce the dark-state light leakage and achieve enhanced contrast.

To achieve the above objective, the present invention provides an array substrate for a LCD device. The LCD device contains an upper polarizer film whose polarization is along a first direction, a second polarizer film whose polarization is along a second direction perpendicular to the first direction, and a black matrix. The array substrate contains a number of pixel units, each containing at least a metallic line for supplying voltage. Each metallic line contains a number of first and second segments end-to-end connected alternately. The first segments are extended along the first direction and are arranged along a third direction at intervals. Each second segment connects adjacent ends of a pair of neighboring first segments. Each metallic line therefore is extended along the third direction that is other than the first and second directions in a stairwise manner, and at least a first or second segment of each metallic line has an included angle relative to the first or second direction less than a preset value. The metallic lines lie within the projection of the black matrix on the array substrate.

The second segments are extended along the second direction.

The first direction is the lateral direction, and the second direction is the vertical direction.

To achieve the above objective, the present invention provides another array substrate for a LCD device. The LCD device contains an upper polarizer film whose polarization is along a first direction, a second polarizer film whose polarization is along a second direction perpendicular to the first direction, and a black matrix. The array substrate contains a number of pixel units, each containing at least a metallic line for supplying voltage. Each metallic line is configured in a stairwise manner along a third direction that is other than the first and second directions, and at least a segment of each metallic line has an included angle relative to the first or second direction less than a preset value.

Each metallic line contains a number of first and second segments end-to-end connected alternately. The first segments are extended along the first direction and are arranged along the third direction at intervals. Each second segment connects adjacent ends of a pair of neighboring first segments. Each metallic line therefore is extended along the third direction in a stairwise manner.

The second segments are extended along the second direction.

The first direction is the lateral direction; and the second direction is the vertical direction.

The metallic lines lie within the projection of the black matrix on the array substrate.

To achieve the above objective, the present invention further provides a LCD device containing an upper polarizer film having a first polarization direction, a second polarizer film having a second polarization direction perpendicular to the first direction, and a liquid crystal panel sandwiched between the first and second polarizer films. The liquid crystal panel contains an array substrate, a color filter substrate, and a liquid crystal layer sandwiched between the array substrate and the color filter substrate. The array substrate contains a number of pixel units, each containing at least a metallic line for supplying voltage. Each metallic line is configured in a stairwise manner along a third direction that is other than the first and second directions. At least a segment of each metallic line has an included angle relative to the first or second direction less than a preset value.

Each metallic line contains a number of first and second segments end-to-end connected alternately. The first segments are extended along the first direction and are arranged along the third direction at intervals. Each second segment connects adjacent ends of a pair of neighboring first segments. Each metallic line therefore is extended along the third direction in a stairwise manner.

The second segments are extended along the second direction.

The first direction is the lateral direction; and the second direction is the vertical direction.

The color filter substrate contains a black matrix, and the metallic lines lie within the projection of the black matrix on the array substrate.

Compared to the prior art, in the array substrate of the present invention, the metallic lines of the pixel units are extended along a third direction that is other than the polarization directions of the upper and lower polarizer films. Therefore, some segments of each metallic line have an included angle relative to one of the polarization directions less than a preset value. Then, when the liquid crystal molecules are aligned subsequently, liquid crystal molecules on these segments' sloes are aligned along directions having included angles relative to one of the polarization directions smaller than the preset vale. As the polarized light from the upper polarizer film passes through the liquid crystal molecules on these segments' slopes, the polarization direction of the polarized light is less twisted by these liquid crystal molecules. As such less polarized light run through the lower polarizer film, reducing the dark-state light leakage and enhancing contrast.

### BRIEF DESCRIPTION OF THE DRAWINGS

To make the technical solution of the embodiments according to the present invention, a brief description of the drawings that are necessary for the illustration of the embodiments will be given as follows. Apparently, the drawings described below show only example embodiments of the present invention and for those having ordinary skills in the art, other drawings may be easily obtained from these drawings without paying any creative effort. In the drawings:

FIG. 1 is a schematic diagram showing a pixel unit in a conventional LCD device;

FIG. 2 is a schematic cross-sectional diagram showing a metallic line of the pixel unit of FIG. 1 and liquid crystal molecules on the metallic line;

FIG. 3 is a schematic diagram showing the alignment of the liquid crystal molecules on a section of a metallic line circled in FIG. 1;

FIG. 4 is a schematic diagram showing a LCD device according to a first embodiment of the present invention;

FIG. 5 is a schematic diagram showing a pixel unit of an array substrate of the LCD device of FIG. 4;

FIG. 6 is a schematic diagram showing alignment of liquid crystal molecules on the slopes of an metallic line of the array substrate of FIG. 5;

FIG. 7 is a schematic diagram showing a metallic line of a LCD device according to a second embodiment of the present invention; and

FIG. 8 is a schematic diagram showing a metallic line of a LCD device according to a third embodiment of the present invention.

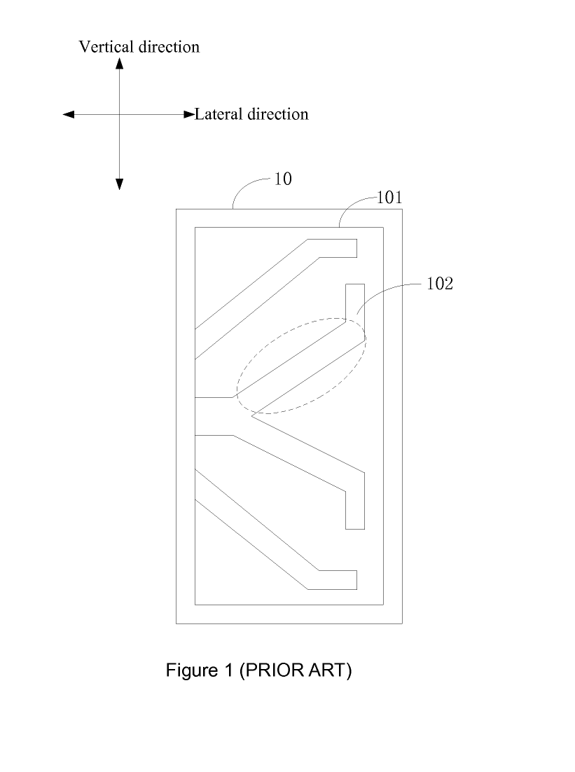

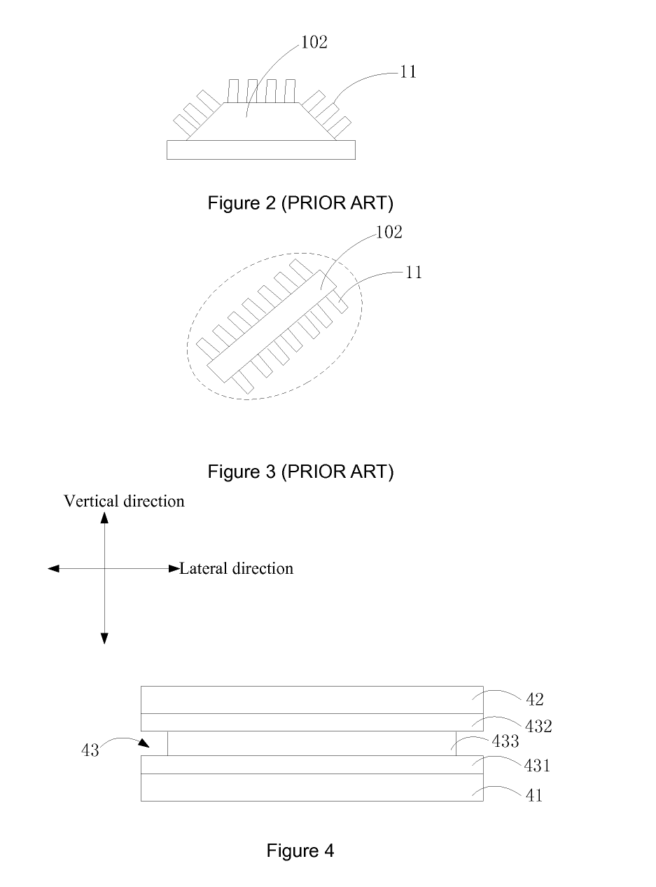

### DETAILED DESCRIPTION OF THE PREFERRED EMBODIMENTS

FIG. 4 is a schematic diagram showing a liquid crystal display (LCD) device according to a first embodiment of the present invention. As illustrated, the LCD device contains an upper polarizer film 41 and a lower polarizer film 42 of different polarization directions, a liquid crystal panel 43 between the upper and lower polarizer films 41 and 42. The liquid crystal panel 43 contains an array substrate 431, a color filter substrate 432, and a liquid crystal layer 433 sandwiched between the array substrate 431 and the color filter substrate 432.

More specifically, the upper and lower polarizer films 41 and 42 have polarization directions along a first direction and a second direction, respectively. The first and second directions are perpendicular to each other. In the present embodiment, the first direction is the lateral direction, and the second direction is the vertical direction as shown in FIG. 4. Alternatively, the first direction can be another direction whereas the second direction is perpendicular to the first direction.

More specifically, the color filter substrate 432 contains a black matrix (not shown).

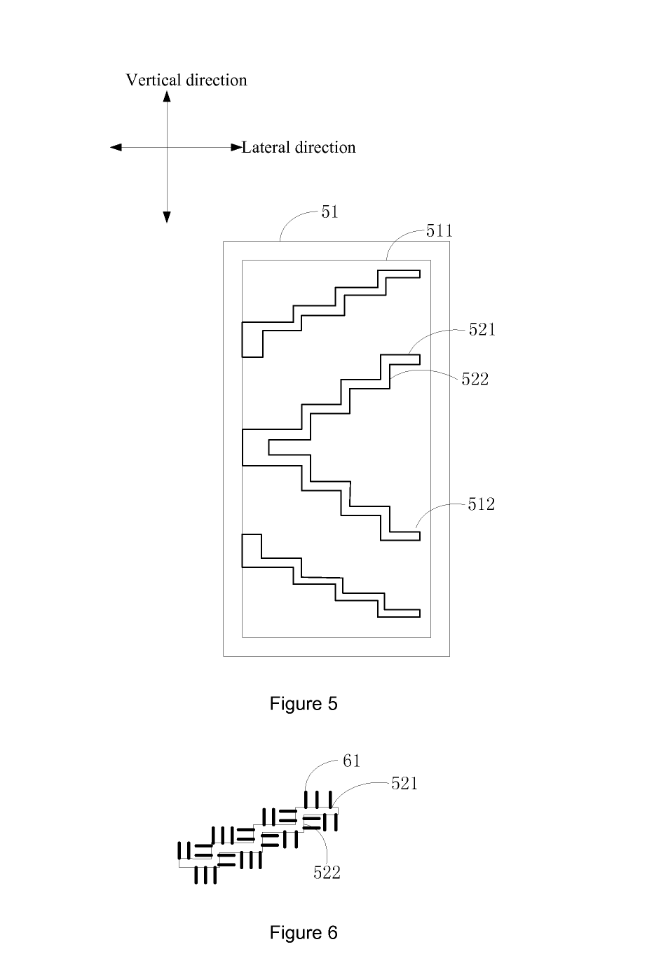

As shown in FIG. 5, the array substrate 431 contains a number of pixel units 51, each containing a pixel electrode 511, and a number of metallic lines 512 for applying voltage to the pixel electrode 511. Alternatively, the metallic lines 512 can also be for applying voltage to a common electrode.

Each metallic line 512 is configured in a stairwise manner along a third direction that is other than the lateral and vertical directions. In this manner, at least some segments of the metallic line 512 has an included angle relative to the lateral or vertical direction less than a preset value. The preset value is 1˜10°, such as 1.5°, 5°, etc.

The metallic lines 512 lie within the projection of the black matrix of the color filter substrate 432 on the array substrate 431 so that the metallic lines 512 do not block light going through the array substrate 431.

The third direction can be one that is 45° relative to the lateral direction, or that is 15°, 60°, or another degree relative to the lateral direction.

By having at least some segments of the metallic line 512 with smaller included angles relative to the lateral or vertical direction, these segments of the metallic line 512 would have smaller included angles relative to the first direction of the upper polarizer film 41 or the second direction of the lower polarizer film 42. As such, liquid crystal molecules on these segments' slopes are aligned along directions having smaller included angles relative to the first or second directions. Since each liquid crystal molecule has a long axis and a perpendicular short axis, and when the alignment direction of the liquid crystal molecules on these segments' slopes has a smaller included angle with the polarization direction of the upper polarizer film 41, light is polarized after passing through the upper polarizer film 41, and the polarized light, as it further passes through the liquid crystal molecules on these segments' slopes, its polarization direction would have a smaller included angle with the long axes of the liquid crystal molecules. Since the polarization direction is less twisted by these liquid crystal molecules, there is less light that will pass through the lower polarizer film 42, thereby reducing the dark-state light leakage. Similarly, when the alignment direction of the liquid crystal molecules on these segments' slopes has a smaller included angle with the polarization direction of the lower polarizer film 42, the alignment direction is closer to be perpendicular to the polarization direction of the upper polarizer film 41. As light is polarized after passing through the upper polarizer film 41, and the polarized light, as it further passes through the liquid crystal molecules on these segments' slopes, its polarization direction would have a smaller included angle with the short axes of the liquid crystal molecules. Since the polarization direction is less twisted by these liquid crystal molecules, there is less light that will pass through the lower polarizer film 42, also reducing the dark-state light leakage.

More specifically, each metallic line 512 contains a number of first segments 521 and second segments 522, end-to-end connected alternately. The first segments 521 are extended laterally and they are arranged along the third direction at intervals. Each second segment 522 connects adjacent ends of a pair of neighboring first segments 521. As such, the metallic line 512 is extended along the third direction in a stairwise manner. Furthermore, the second segments 522 are extended vertically and therefore, in the present embodiment, the first segments 521 have a 0° included angle with the lateral direction whereas the second segments 522 have a 0° included angle with the vertical direction.

Therefore, when the liquid crystal molecules in the liquid crystal layer 43 are aligned, as shown in FIG. 6, the liquid crystal molecules 61 on the first segments 521's slopes are aligned along the vertical direction (i.e., the same as the lower polarizer film 42's polarization direction) whereas the liquid crystal molecules 61 on the second segments 522's slopes are aligned along the lateral direction (i.e., the same as the upper polarizer film 41's polarization direction). Therefore, the polarized light from the upper polarizer film 41, as it passes through the liquid crystal molecules 61 on the first segments 521's slopes, the polarized light penetrates through the short axes of these liquid crystal molecules 61. As the polarized light passes through the liquid crystal molecules 61 on the second segments 522's slopes, the polarized light penetrates through the long axes of these liquid crystal molecules 61. The polarization direction of the polarized light is not twisted by liquid crystal molecules 61 in either scenario. The polarized light therefore cannot run through the lower polarizer film 42, reducing the dark-state light leakage and enhancing contrast.

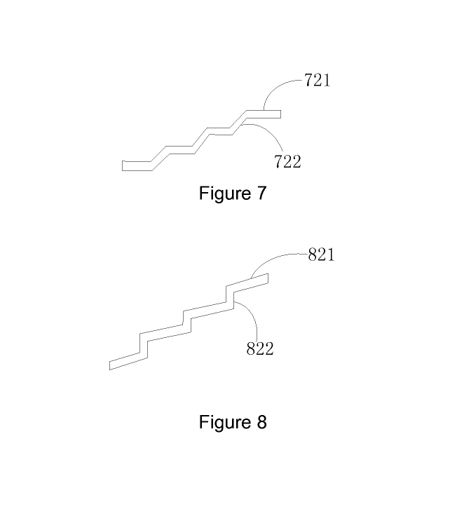

As shown in FIG. 7, in a second embodiment of the present invention, the second segments 722 of each metallic line has an included angle relative to the vertical direction whereas the first segments 721 are extended along the lateral direction. Alternatively, in the third embodiment of the present invention as shown in FIG. 8, the first segments 821 has an included angle relative to the lateral direction whereas the second segments 822 are extended along the vertical direction.

Of course both the first and second segments can have included angles relative to lateral and vertical directions where the included angles can be 5°, 7°, etc. The included angles can be other appropriate values as long as the alignment directions of the liquid crystal molecules on the metallic lines' slopes are as much close to the lateral or vertical direction as possible.

The present invention also provides an array substrate for use in LCD devices. The array substrate is as described above.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the clams of the present invention.

What is claimed is:

1. An array substrate for a liquid crystal display (LCD) device, the LCD device comprising an upper polarizer film whose polarization is along a first direction, a second polarizer film whose polarization is along a second direction perpendicular to the first direction, and a black matrix, the array substrate comprising
a plurality of pixel units, each comprising at least a metallic line for supplying voltage where each metallic line comprises a plurality of first and second segments end-to-end connected alternately, the first segments are extended along the first direction and are arranged along a third direction at intervals, each second segment connects adjacent ends of a pair of neighboring first segments, each metallic line therefore is extended along the third direction that is other than the first and second directions in a stairwise manner, at least a first or second segment of each metallic line has an included angle relative to the first or second direction less than a preset value, and the metallic lines lie within the projection of the black matrix on the array substrate.

2. The array substrate as claimed in claim 1, wherein the second segments are extended along the second direction.

3. The array substrate as claimed in claim 1, wherein the first direction is the lateral direction; and the second direction is the vertical direction.

4. An array substrate for a liquid crystal display (LCD) device, the LCD device comprising an upper polarizer film whose polarization is along a first direction, a second polarizer film whose polarization is along a second direction perpendicular to the first direction, and a black matrix, the array substrate comprising
a plurality of pixel units, each comprising at least a metallic line for supplying voltage where each metallic line is configured in a stairwise manner along a third direction that is other than the first and second directions, and at least a segment of each metallic line has an included angle relative to the first or second direction less than a preset value.

5. The array substrate as claimed in claim 4, wherein each metallic line comprises a plurality of first and second segments end-to-end connected alternately; the first segments are extended along the first direction and are arranged along the third direction at intervals; each second segment connects adjacent ends of a pair of neighboring first segments; and each metallic line therefore is extended along the third direction in a stairwise manner.

6. The array substrate as claimed in claim 5, wherein the second segments are extended along the second direction.

7. The array substrate as claimed in claim 5, wherein the first direction is the lateral direction; and the second direction is the vertical direction.

8. The array substrate as claimed in claim 4, wherein the metallic lines lie within the projection of the black matrix on the array substrate.

9. A LCD device, comprising
an upper polarizer film having a first polarization direction;
a second polarizer film having a second polarization direction perpendicular to the first direction; and
a liquid crystal panel sandwiched between the first and second polarizer films;
wherein the liquid crystal panel comprises an array substrate, a color filter substrate, and a liquid crystal layer sandwiched between the array substrate and the color filter substrate; the array substrate comprises a plurality of pixel units, each comprising at least a metallic line for supplying voltage; each metallic line is configured in a stairwise manner along a third direction that is other than the first and second directions; and at least a segment of each metallic line has an included angle relative to the first or second direction less than a preset value.

10. The LCD device as claimed in claim 9, wherein each metallic line comprises a plurality of first and second segments end-to-end connected alternately; the first segments are extended along the first direction and are arranged along the third direction at intervals; each second segment connects adjacent ends of a pair of neighboring first segments; and each metallic line therefore is extended along the third direction in a stairwise manner.

11. The array substrate as claimed in claim 10, wherein the second segments are extended along the second direction.

12. The LCD device as claimed in claim 10, wherein the first direction is the lateral direction; and the second direction is the vertical direction.

13. The LCD device as claimed in claim 9, wherein the color filter substrate comprises a black matrix; and the metallic lines lie within the projection of the black matrix on the array substrate.
